(19) United States
(12) Patent Application Publication
(10) Pub. No.: US 2024/0018312 A1
(43) Pub. Date: Jan. 18, 2024

(54) METHOD FOR ENHANCING ADHESION STRENGTH OF RESIN MOLDED ARTICLE TO AN ADHESIVE, AND COMPOSITE ENHANCED IN ADHESION STRENGTH

(71) Applicant: ENEOS Corporation, Tokyo (JP)

(72) Inventors: Ryoto KAWAMURA, Tokyo (JP); Ayaka SEICHI, Tokyo (JP)

(73) Assignee: ENEOS Corporation, Tokyo (JP)

(21) Appl. No.: 18/250,250

(22) PCT Filed: Oct. 27, 2021
(86) PCT No.: PCT/JP2021/039590

§ 371 Date: Apr. 24, 2023

(30) Foreign Application Priority Data
Oct. 28, 2020 (JP) 2020-180648

(51) Int. Cl. C08J 3/20; C09K 19/38; C09J 133/08; C08K 3/26; C08J 7/043; C09J 163/00; C08K 3/013

(52) U.S. Cl. CPC C08J 3/201; C09K 19/3809; C09J 133/08; C08K 3/26; C08J 7/043; C09J 163/00; C08K 3/013; C08J 2481/06; C08J 2467/03

(57) ABSTRACT

The invention provides a method for enhancing adhesion strength to an adhesive without any loss of mechanical strength of a resin molded article. In particular, the invention provides a method for enhancing adhesion strength of a resin molded article made of a resin composition including a liquid crystal polymer resin and an inorganic filling agent, to an adhesive, in which an amorphous resin is further compounded into the resin composition, and an amount of compounding of the liquid crystal polymer resin, an amount of compounding of the amorphous resin, and an amount of compounding of the inorganic filling agent are respectively regulated to 50-99 parts by mass, 1-50 parts by mass, and 0.1-120 parts by mass, based on 100 parts by mass in total of the liquid crystal polymer resin and the amorphous resin.

### BACKGROUND OF THE INVENTION

### Field of the Invention

The present invention relates to a method for enhancing adhesion strength of a resin molded article made of a resin composition including a liquid crystal polymer resin and an inorganic filling agent, to an adhesive. The present invention also relates to a composite enhanced in adhesion strength, obtained by bonding a resin molded article and other member by an adhesive.

### Background Art

Resin molded articles made of liquid crystal polymer resin compositions, while bonded with other members by adhesives and then used, have possibly caused peeling of adhesion portions due to low adhesion strength of liquid crystal polymer resins themselves. As in Patent Literature 1 to 3, there has been then conventionally used a method for enhancing adhesion strength by addition of a large amounts of a filling agent, such as glass fiber and/or talc, to a resin composition and thus exertions of the effect of an increase in apparent adhesion area due to roughening of the surface of a resin molded article and the anchor effect of the filling agent itself. However, such a method causes deterioration in appearance of the resin molded article, and thus applicable uses thereof are limited.

Patent Literature 4 to 7 each has proposed a method including adding an epoxy group-containing copolymer for not only suppression of deterioration in appearance and deterioration in dust generation, but also an enhancement in adhesion strength. However, an enhancement in adhesion strength causes deterioration in mechanical strength, and thus the amount of addition cannot be increased and the effect of enhancing adhesion strength is limited.

In this regard, Patent Literature 8 to 11, while each has disclosed enhancements in fluidity and moldability of a resin composition including a liquid crystal polymer resin and polyarylate compounded, each has not disclosed any enhancement in adhesion strength in bonding of a resin molded article and other member by an adhesive, at all.

### CITATION LIST

### Patent Literature

[Patent Literature 1] JP 6416442 B
[Patent Literature 2] JP 5541330 B
[Patent Literature 3] JP 5136324 B
[Patent Literature 4] JP 6545416 B
[Patent Literature 5] JP 6037709 B
[Patent Literature 6] JP 2011-137064 A
[Patent Literature 7] JP 2019-73591 A
[Patent Literature 8] JP H5-5054 A
[Patent Literature 9] JP 4135064 B
[Patent Literature 10] JP 2004-315776 A
[Patent Literature 11] JP 2010-83930 A

### SUMMARY OF THE INVENTION

### Technical Problem

Liquid crystal polymer resin compositions are excellent in fluidity and dimension stability, and thus are used for electronic components in mobile devices such as smartphones, tablets, and notebook PCs, and for constituent members of in-vehicle electronic components. In manufacturing processes of these, resin molded articles made of such liquid crystal polymer resin compositions are often bonded with other members by adhesives and then used.

In recent years, there has occurred a need for decrease in coating area with adhesives according to reduction in size of electronic components, and resin molded articles and adhesives have been demanded to be enhanced in adhesion strength. On the other hand, there is a need for avoidance of reduction in mechanical strength of resin molded articles themselves because components of mobile devices or vehicles, when used, may be damaged due to application of strong impact or vibration in the use environment. In other words, there is a demand for methods for enhancing adhesion strength between resin molded articles and adhesives with mechanical strength of resin molded articles made of liquid crystal polymer resin compositions being kept.

Accordingly, an object of the present invention is to provide a method for enhancing adhesion strength to an adhesive without any loss of mechanical strength of a resin molded article. An object of the present invention is to provide a composite enhanced in adhesion strength, obtained by bonding a resin molded article and other member by an adhesive.

### Solution to Problem

The present inventor has made intensive studies in order to solve the above problems, and as a result, has found that the above problems can be solved by further compounding an amorphous resin to a resin molded article made of a resin composition including a liquid crystal polymer resin and an inorganic filling agent, and regulating the amounts of compounding of the liquid crystal polymer resin, the amorphous resin and the inorganic filling agent. The present invention has been completed based on such a finding.

In other words, one aspect of the present invention provides
a method for enhancing adhesion strength of a resin molded article made of a resin composition including a liquid crystal polymer resin and an inorganic filling agent, to an adhesive, wherein
an amorphous resin is further compounded into the resin composition, and
an amount of compounding of the liquid crystal polymer resin, an amount of compounding of the amorphous resin, and an amount of compounding of the inorganic filling agent are respectively regulated to 50 parts by mass or more and 99 parts by mass or less, 1 part by mass or more and 50 parts by mass or less, and 0.1 parts by mass or more and 120 parts by mass or less, based on 100 parts by mass in total of the liquid crystal polymer resin and the amorphous resin.

In an aspect of the present invention, the amount of compounding of the liquid crystal polymer resin and the amount of compounding of the amorphous resin are preferably respectively regulated to 70 parts by mass or more and 99 parts by mass or less and 1 part by mass or more and 30 parts by mass or less.

In an aspect of the present invention, the amorphous resin is preferably at least one selected from the group consisting of polyarylate, polyethersulfone, polysulfone, polyphenylene ether, and polycarbonate.

In an aspect of the present invention, the amorphous resin is preferably at least one selected from the group consisting of polyarylate and polysulfone.

In an aspect of the present invention, 1 part by mass or more and 5 parts by mass or less of an epoxy group-containing copolymer based on 100 parts by mass in total of the liquid crystal polymer resin and the amorphous resin is preferably further compounded into the resin composition.

In an aspect of the present invention, the liquid crystal polymer resin preferably contains the following structural unit (I) derived from hydroxycarboxylic acid:

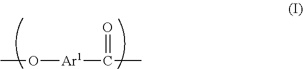

wherein Ar¹ is selected from the group consisting of a phenyl group, a biphenyl group, a 4,4′-isopropylidenediphenyl group, a naphthyl group, an anthryl group and a phenanthryl group each optionally having a substituent.

In an aspect of the present invention, the liquid crystal polymer resin preferably further contains the following structural unit (II) derived from a diol compound:

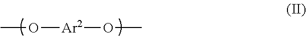

wherein Ar² is selected from the group consisting of a phenyl group, a biphenyl group, a 4,4′-isopropylidenediphenyl group, a naphthyl group, an anthryl group and a phenanthryl group each optionally having a substituent; and
the following structural unit (III) derived from dicarboxylic acid:

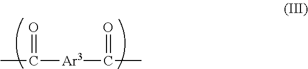

wherein Ar³ is selected from the group consisting of a phenyl group, a biphenyl group, a 4,4′-isopropylidenediphenyl group, a naphthyl group, an anthryl group and a phenanthryl group each optionally having a substituent.

In an aspect of the present invention, the liquid crystal polymer resin further contains the following structural unit (IV).

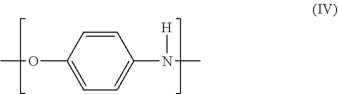

In an aspect of the present invention, the liquid crystal polymer resin preferably further contains the following structural unit (V).

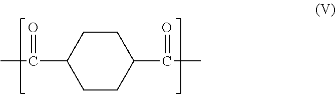

In an aspect of the present invention, the inorganic filling agent is preferably at least one selected from the group consisting of talc, mica, glass, silica, wollastonite, barium sulfate, calcium pyrophosphate, calcium sulfate, calcium titanate, calcium carbonate, zinc oxide, titanium oxide, carbon black, and carbon fiber.

In an aspect of the present invention, the adhesive is preferably an epoxy-based adhesive and/or an acrylate-based adhesive.

Another aspect of the present invention provides a resin composition for use in a method for enhancing adhesion strength of a resin molded article to an adhesive, the resin composition including
50 parts by mass or more and 99 parts by mass or less of a liquid crystal polymer resin and 1 part by mass or more and 50 parts by mass or less of an amorphous resin, and 0.1 parts by mass or more and 120 parts by mass or less of an inorganic filling agent based on 100 parts by mass in total of the liquid crystal polymer resin and the amorphous resin.

Another aspect of the present invention provides a composite obtained by bonding a resin molded article made of a resin composition including 50 parts by mass or more and 99 parts by mass or less of a liquid crystal polymer resin and 1 part by mass or more and 50 parts by mass or less of an amorphous resin, and 0.1 parts by mass or more and 120 parts by mass or less of an inorganic filling agent based on 100 parts by mass in total of the liquid crystal polymer resin and the amorphous resin, with other member, by an adhesive.

In another aspect of the present invention, the adhesive is preferably an epoxy-based adhesive and/or an acrylate-based adhesive.

Still another aspect of the present invention provides a camera module component including the composite as a constituent member.

### Advantageous Effects of Invention

The present invention can provide a method for enhancing adhesion strength to an adhesive without any loss of mechanical strength of a resin molded article. The present invention can also provide a composite enhanced in adhesion strength, obtained by bonding a resin molded article and other member by an adhesive.

### DETAILED DESCRIPTION OF THE INVENTION

[Method for Enhancing Adhesion Strength of Resin Molded Article to Adhesive]

In the present invention, at least a liquid crystal polymer resin, an amorphous resin and an inorganic filling agent can be compounded at specified proportions into a resin composition forming a resin molded article, and thus the resulting resin molded article can be enhanced in adhesion strength thereof to an adhesive without any loss in mechanical strength thereof.

In general, a resin molded article including only a liquid crystal polymer resin as a resin component cannot exhibit sufficient adhesiveness to a conventionally known adhesive (for example, an epoxy-based adhesive or an acrylate-based adhesive). The reason presumed is that a layer to be easily peeled, called a skin layer, is formed on a surface layer of a resin molded article including only a liquid crystal polymer resin as a resin component and causes low adhesion strength of such a liquid crystal polymer resin. On the other hand, the present invention can allow for an enhancement in adhesion strength to an adhesive such as an epoxy-based adhesive and/or an acrylate-based adhesive by compounding of a liquid crystal polymer resin and additionally an amorphous resin, as resin components. The reason presumed is that a portion of the amorphous resin, exposed on a surface of a resin molded article, can increase adhesiveness to the adhesive. The reason presumed is also that the amorphous resin as a resin component can be compounded to thereby relax orientation of the liquid crystal polymer resin and thus somewhat relax formation of a skin layer, and obscure an interface between the skin layer and an inner core layer, thereby making it difficult to peel the skin layer to result in an increase in adhesiveness. Hereinafter, each component included in the resin composition is described.

(Liquid Crystal Polymer Resin)

The liquid crystal polymer resin compounded into the resin composition preferably contains at least a structural unit (I) derived from hydroxycarboxylic acid, and may further contain a structural unit (II) derived from a diol compound and a structural unit (III) derived from dicarboxylic acid. The resin composition may include only one kind of the liquid crystal polymer resin, or two or more kinds of such resins. Hereinafter, each structural unit contained in the liquid crystal polymer resin is described.

(Structural Unit (I) Derived from Hydroxycarboxylic Acid)

The unit (I) constituting the liquid crystal polymer resin is an aromatic hydroxycarboxylic acid-derived structural unit represented by the following formula (I). Only one kind of the structural unit (I), or two or more kinds thereof may be contained.

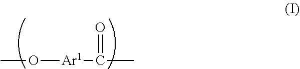

In the formula, Art is selected from the group consisting of a phenyl group, a biphenyl group, a 4,4′-isopropylidenediphenyl group, a naphthyl group, an anthryl group and a phenanthryl group each optionally having a substituent. In particular, a phenyl group, a biphenyl group, and a naphthyl group are preferable, and a naphthyl group is more preferable. Examples of the substituent include hydrogen, an alkyl group, an alkoxy group, and fluorine. The number of carbon atoms in the alkyl group is preferably 1 to 10, more preferably 1 to 5. A linear alkyl group or a branched alkyl group may be adopted. The number of carbon atoms in the alkoxy group is preferably 1 to 10, more preferably 1 to 5.

Examples of a monomer imparting the structural unit represented by the formula (I) include 6-hydroxy-2-naphthoic acid (HNA, the following formula (1)), p-hydroxybenzoic acid (HBA, the following formula (2)), and acylated products, ester derivatives and acid halides thereof.

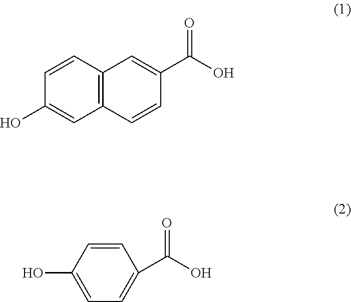

The lower limit value of the compositional ratio (% by mol) of the structural unit (I) to the total structural unit of the liquid crystal polymer resin is preferably 30% by mol or more, more preferably 35% by mol or more, further preferably 40% by mol or more, still more preferably 45% by mol or more, and the upper limit value thereof is preferably 100% by mol or less, more preferably 95% by mol or less, further preferably 90% by mol or less, still more preferably 85% by mol or less. When the structural unit (I) is contained in combination of two or more kinds thereof, the total molar ratio may fall within the compositional ratio range.

(Structural Unit (II) Derived from Diol Compound)

The unit (II) constituting the liquid crystal polymer resin is an aromatic diol compound-derived structural unit represented by the following formula (II). Only one kind of the structural unit (II), or two or more kinds thereof may be contained.

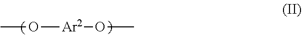

In the formula, Ar² is selected from the group consisting of a phenyl group, a biphenyl group, a 4,4′-isopropylidenediphenyl group, a naphthyl group, an anthryl group and a phenanthryl group each optionally having a substituent. In particular, a phenyl group and a biphenyl group are more preferable. Examples of the substituent include hydrogen, an alkyl group, an alkoxy group, and fluorine. The number of carbon atoms in the alkyl group is preferably 1 to 10, more preferably 1 to 5. A linear alkyl group or a branched alkyl group may be adopted. The number of carbon atoms in the alkoxy group is preferably 1 to 10, more preferably 1 to 5.

Examples of a monomer imparting the structural unit (II) include 4,4′-dihydroxybiphenyl (BP, the following formula (3)), hydroquinone (HQ, the following formula (4)), methylhydroquinone (MeHQ, the following formula (5)), 4,4′-isopropylidenediphenol (BisPA, the following formula (6)), resorcinol, and acylated products, ester derivatives and acid halides thereof. In particular, 4,4′-dihydroxybiphenyl(BP), and acylated products, ester derivatives and acid halides thereof are preferably used.

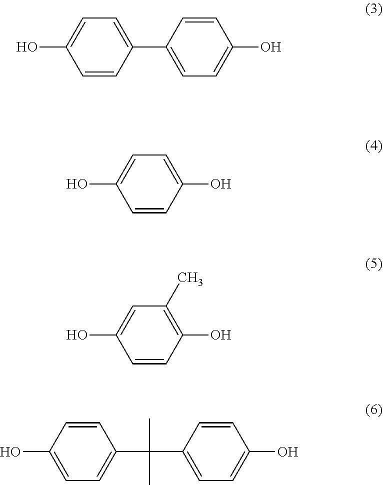

The lower limit value of the compositional ratio (% by mol) of the structural unit (II) to the total structural unit of the liquid crystal polymer resin is preferably 0% by mol or more, more preferably 2.5% by mol or more, further preferably 5% by mol or more, still more preferably 7.5% by mol or more, and the upper limit value thereof is preferably 35% by mol or less, more preferably 32.5% by mol or less, further preferably 30% by mol or less, still more preferably 27.5% by mol or less. When the structural unit (II) is contained in combination of two or more kinds thereof, the total molar ratio may fall within the compositional ratio range.

(Structural Unit (III) Derived from Aromatic Dicarboxylic Acid)

The unit (III) constituting the liquid crystal polymer resin is an aromatic dicarboxylic acid-derived structural unit represented by the following formula (III). Only one kind of the structural unit (III), or two or more kinds thereof may be contained.

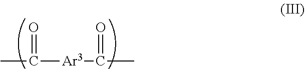

In the formula, Ar³ is selected from the group consisting of a phenyl group, a biphenyl group, a 4,4′-isopropylidenediphenyl group, a naphthyl group, an anthryl group and a phenanthryl group each optionally having a substituent. In particular, a phenyl group and a biphenyl group are more preferable. Examples of the substituent include hydrogen, an alkyl group, an alkoxy group and fluorine. The number of carbon atoms in the alkyl group is preferably 1 to 10, more preferably 1 to 5. A linear alkyl group or a branched alkyl group may be adopted. The number of carbon atoms in the alkoxy group is preferably 1 to 10, more preferably 1 to 5.

Examples of a monomer imparting the structural unit (III) include terephthalic acid (TPA, the following formula (7)), isophthalic acid (IPA, the following formula (8)), 2,6-naphthalenedicarboxylic acid (NADA, the following formula (9)), and acylated products, ester derivatives and acid halides thereof.

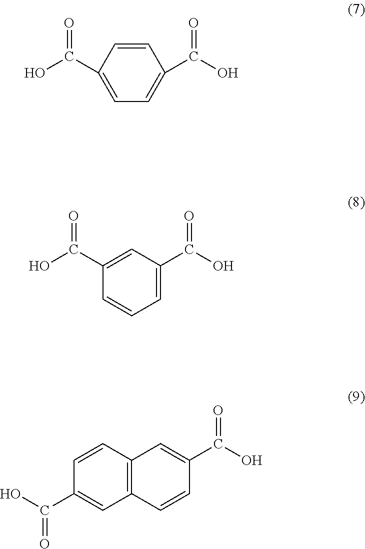

The lower limit value of the compositional ratio (% by mol) of the structural unit (III) to the total structural unit of the liquid crystal polymer resin is preferably 0% by mol or more, more preferably 2.5% by mol or more, further preferably 5% by mol or more, still more preferably 7.5% by mol or more, and the upper limit value thereof is preferably 35% by mol or less, more preferably 32.5% by mol or less, further preferably 30% by mol or less, still more preferably 27.5% by mol or less. When the structural unit (II) is contained in combination of two or more kinds thereof, the total molar ratio may fall within the compositional ratio range. The compositional ratio structural unit (II) and the compositional ratio of the structural unit (III) are substantially equivalent to each other ((structural unit (II)≈structural unit (III)).

(Structural Unit (IV))

The liquid crystal polymer resin may further contain the following structural unit (IV), in addition to the structural units (I) to (III).

Examples include:

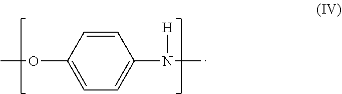

Examples of a monomer imparting the structural unit (IV) include acetaminophen (AAP, the following formula (10)), p-aminophenol, 4′-acetoxyacetanilide, and acylated products, ester derivatives and acid halides thereof.

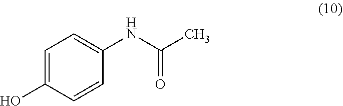

(Structural Unit (V))

The liquid crystal polymer resin may further contain the following structural unit (V), in addition to the structural units (I) to (III).

Examples include:

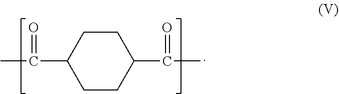

Examples of a monomer imparting the structural unit (V) include 1,4-cyclohexanedicarboxylic acid (CHDA, the following formula (11)), and acylated products, ester derivatives and acid halides thereof.

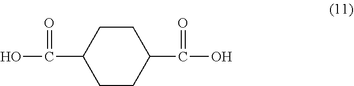

The compositional ratio (% by mol) of the structural units (IV) and (V) to the total structural unit of the liquid crystal polymer resin can be appropriately set depending on the compositional ratio of the structural units (I) to (III). For example, the compositional ratio of the structural unit (I) may be set and then the compositional ratio of the structural units (II), (III), (IV) and (V) may be appropriately set so that the monomer ratio (molar ratio) between a carboxyl group in monomer loading and a hydroxy group and/or an amine group falls within about 1:1. The total compositional ratio of the structural units (II) and (IV) and the total compositional ratio of the structural units (III) and (V) are substantially equivalent to each other ((structural units (II)+(IV)≈structural units (III)+(V)).

The liquid crystallinity of the liquid crystal polymer resin can be confirmed with a polarization microscope (trade name: BH-2) manufactured by OLYMPUS CORPORATION, equipped with a hot stage for microscopes (trade name: FP82HT) manufactured by METTLER TOLEDO, by heating and melting the liquid crystal polymer resin on a microscope heating stage and then observing the presence of optical anisotropy.

(Method for Producing Liquid Crystal Polymer Resin)

The liquid crystal polymer resin can be produced by polymerizing monomers optionally imparting structural units (I) to (III) and monomers optionally imparting structural units (IV) and (V), according to a conventionally known method. In one embodiment, the liquid crystal polymer resin can be produced by two-stage polymerization where a prepolymer is produced by melt polymerization and further is subjected to solid phase polymerization.

The melt polymerization is preferably performed under acetic acid reflux, by combining monomers optionally imparting the structural units (I) to (III) and monomers optionally imparting structural units (IV) and (V) by predetermined compounding so that the total reaches 100% by mol and allowing 1.03 to 1.15 molar equivalents of acetic anhydride to be present based on the total hydroxyl group in the monomers, from the viewpoint of efficiently providing the liquid crystal polymer resin.

In the case of a polymerization reaction at two stages of the melt polymerization and subsequent solid phase polymerization, a method is preferably selected which is, for example, a method involving cooling and solidifying and then pulverizing the prepolymer obtained by the melt polymerization, to thereby provide a powdery or flaky prepolymer, and thereafter performing a known solid phase polymerization method, for example, a method of heat-treating such a prepolymer resin at a temperature ranging from 200 to 350° C. under an atmosphere of an inert gas such as nitrogen or under vacuum for 1 to 30 hours. The solid phase polymerization may be performed with stirring or under still standing with no stirring.

A catalyst may or may not be used in the polymerization reaction. The catalyst used can be any conventionally known catalyst for liquid crystal polymer formation, and examples include metal salt catalysts such as magnesium acetate, stannous acetate, tetrabutyl titanate, lead acetate, sodium acetate, potassium acetate and antimony trioxide, and organic compound catalysts such as a nitrogen-containing heterocyclic compound such as N-methylimidazole. The amount of the catalyst used is not particularly limited, and is preferably 0.0001 to 0.1 parts by weight based on 100 parts by weight of the total monomer.

The polymerization reaction apparatus in the melt polymerization is not particularly limited, and a reaction apparatus for use in a general reaction of a high-viscosity fluid is preferably used. Examples of such a reaction apparatus include mixing apparatuses commonly used in resin kneading, for example, a stirring tank-type polymerization reaction apparatus having a stirring apparatus provided with a stirring blade having any shape such as an anchor, multiple-stage, spiral band or spiral shaft shape, or a modified shape thereof, or a kneader, a roll mill or a banbury mixer.

(Amorphous Resin)

Examples of the amorphous resin to be compounded into the resin composition include polyarylate, polyethersulfone, polysulfone, polyphenylsulfone, polyphenylene ether, and polycarbonate, polyarylate and polysulfone are preferable, and polyarylate is more preferable. Only one kind, or two or more kinds of such amorphous resins may be used.

The polyarylate is an amorphous aromatic polyester polymer of an aromatic dicarboxylic acid or its derivative and dihydric phenol or its derivative. Examples of a raw material for introduction of an aromatic dicarboxylic acid residue include terephthalic acid, isophthalic acid, phthalic acid, chlorophthalic acid, nitrophthalic acid, 2,5-naphthalenedicarboxylic acid, 2,6-naphthalenedicarboxylic acid, 2,7-naphthalenedicarboxylic acid, 1,5-naphthalenedicarboxylic acid, methylterephthalic acid, 4,4′-biphenyldicarboxylic acid, 2,2′-biphenyldicarboxylic acid, 4,4′-diphenyl ether dicarboxylic acid, 4,4′-diphenylmethanedicarboxylic acid, 4,4′-diphenylsulfonedicarboxylic acid, 4,4′-diphenylisopropylidenedicarboxylic acid, 1,2-bis(4-carboxyphenoxy)ethane, and 5-sodium sulfoisophthalic acid. A raw material for introduction of a bisphenol residue is bisphenol, and specific examples thereof include resorcinol, 4,4′-isopropylidenediphenol, 2,2-bis(4-hydroxy-3,5-dimethylphenyl)propane, 2,2-bis(4-hydroxy-3-methylphenyl)propane, 2,2-bis(4-hydroxy-3,5-dibromophenyl)propane, 2,2-bis(4-hydroxy-3,5-dichlorophenyl)propane, 4,4′-dihydroxydiphenylsulfone, 4,4′-dihydroxydiphenyl ether, 4,4′-dihydroxydiphenylsulfide, 4,4′-dihydroxydiphenyl ketone, 4,4′-dihydroxydiphenylmethane, 1,1-bis(4-hydroxyphenyl)cyclohexane, and 3,3,5-trimethyl-1,1-bis(4-hydroxyphenyl)cyclohexane.

(Inorganic Filling Agent)

Examples of the inorganic filling agent to be compounded into the resin composition include talc, mica, glass, silica, wollastonite, barium sulfate, calcium pyrophosphate, calcium sulfate, calcium titanate, calcium carbonate, zinc oxide, titanium oxide, carbon black, and carbon fiber. In particular, talc or wollastonite is preferably used. The shape of the inorganic filling agent is not particularly limited, and can be appropriately selected. Only one kind, or two or more kinds of such inorganic filling agents may be used.

The lower limit value of the amount of compounding of the resin component (total amount of compounding of the liquid crystal polymer resin and the amorphous resin) in the resin composition, relative to the entire resin composition, is generally preferably 30 parts by mass or more, more preferably 40 parts by mass or more, further preferably 45 parts by mass or more, still more preferably 50 parts by mass or more, and the upper limit value thereof is preferably 90 parts by mass or less, more preferably 85 parts by mass or less, further preferably 80 parts by mass or less, still more preferably 75 parts by mass or less.

The amount of compounding of the liquid crystal polymer resin, the amount of compounding of the amorphous resin and the amount of compounding of the inorganic filling agent based on 100 parts by mass in total of the liquid crystal polymer resin and the amorphous resin, in the resin composition, are respectively regulated to 50 parts by mass or more and 99 parts by mass or less, 1 part by mass or more and 50 parts by mass or less and 0.1 parts by mass or more and 120 parts by mass or less, and thus adhesion strength of a resin molded article made of the resin composition, to an adhesive, can be enhanced. The lower limit value of the amount of compounding of the liquid crystal polymer resin based on 100 parts by mass in total of the liquid crystal polymer resin and the amorphous resin is preferably 60 parts by mass or more, more preferably 62 parts by mass or more, still more preferably 65 parts by mass or more. The upper limit value of the amount of compounding of the amorphous resin is preferably 40 parts by mass or less, more preferably 38 parts by mass or less, still more preferably 35 parts by mass or less. The lower limit value of the amount of compounding of the inorganic filling agent is preferably 1 part by mass or more, more preferably 10 parts by mass or more, still more preferably 20 parts by mass or more, and the upper limit value thereof is preferably 110 parts by mass or less, more preferably 100 parts by mass or less, still more preferably 90 parts by mass or less. The respective amounts of compounding of the components can be regulated to result in a more enhancement in adhesion strength to an adhesive without any loss of mechanical strength of the resin molded article.

(Epoxy Group-Containing Copolymer)

An epoxy group-containing copolymer may be further compounded into the resin composition. The epoxy group-containing copolymer can be compounded into the resin composition to result in a more enhancement in adhesion strength to an adhesive.

The epoxy group-containing copolymer is not particularly limited, and examples thereof include an epoxy group-containing olefin-based copolymer and an epoxy group-containing styrene-based copolymer. Examples of the epoxy group-containing olefin-based copolymer include a copolymer including an α-olefin-derived structural unit and an α,β-unsaturated acid glycidyl ester-derived structural unit. The α-olefin is not particularly limited, examples thereof include ethylene, propylene and butene, and in particular ethylene is preferable. Examples of the epoxy group-containing styrene-based copolymer include a copolymer including a styrene-derived structural unit and an α,β-unsaturated acid glycidyl ester-derived structural unit. Examples of such styrene include styrene, α-methylstyrene, brominated styrene, and divinylbenzene, and in particular styrene is preferable.

The amount of compounding of the epoxy group-containing copolymer based on 100 parts by mass in total of the liquid crystal polymer resin and the amorphous resin is preferably 1 part by mass or more and 5 parts by mass or less, more preferably 2 parts by mass or more and 4 parts by mass or less.

(Other Additive)

Other additive may be compounded into the resin composition as long as the effects of the present invention are not impaired. Examples of such other additive include a colorant, a dispersant, a plasticizer, an antioxidant, a curing agent, a flame retardant, a heat stabilizer, an ultraviolet absorber, an antistatic agent, a surfactant, a release agent, and a lubricant.

The amount of compounding of such other additive in the resin composition is preferably 5 parts by mass or less, more preferably 2 parts by mass or less based on 100 parts by mass in total of the liquid crystal polymer resin and the amorphous resin.

(Composite)

The composite of the present invention is obtained by bonding a resin molded article made of the resin composition and other member by an adhesive. The composite is excellent in adhesion strength of the resin molded article and such other member, and thus can be applied in various applications where adhesion strength is required.

(Method for Producing Composite)

In the present invention, the composite can be obtained by molding the resin composition in which the liquid crystal polymer resin, the amorphous resin, the inorganic filling agent, and optionally other additive and/or the like are compounded at specified proportions, by a conventionally known method. The resin composition can be obtained by melt kneading the liquid crystal polymer resin, the amorphous resin, the inorganic filling agent, and optionally other additive and/or the like with a banbury mixer, a kneader, a one- or two-axis extruder, or the like.

Examples of the molding method include press molding, blow molding, foam molding, injection molding, extrusion molding, and punch molding. In particular, melt molding such as injection molding or extrusion molding is preferable, and injection molding is more preferable. The resin molded article produced as described above can be processed into any shape depending on the intended use. The shape of the molded article can be, for example, a plate or film shape.

Subsequently, the resin molded article obtained and other member can be bonded by an adhesive to thereby produce the composite. The adhesive is not particularly limited, and examples thereof include an epoxy-based adhesive and an acrylate-based adhesive.

(Camera Module Component)

The camera module component according to the present invention includes the composite as a constituent member. The camera module component can be utilized in various applications, such as a component constituting an actuator, a lens-barrel part, a mount holder part, a frame of CMOS (image sensor), a shutter and a shutter bobbin part, in, for example, a mobile phone, a laptop computer, a digital camera, a digital video camera, a vehicle-mounted camera, a security camera, a drone, a smartwatch, a smartphone, and a tablet-type terminal-mounted camera. The camera module component, which is reduced in size, is thus excellent in adhesion strength between the resin molded article and other member regardless of a small coating area with an adhesive, and therefore is excellent in impact resistance.

### EXAMPLES

Hereinafter, the present invention is more specifically described with reference to Examples, but the present invention is not limited to these Examples.

### <Production of Liquid Crystal Polymer Resin>

### Synthesis Example 1

Raw material monomers, 60% by mol of p-hydroxybenzoic acid (HBA), 20% by mol of 4,4′-dihydroxybiphenyl (BP), 15% by mol of terephthalic acid (TPA), and 5% by mol isophthalic acid (IPA), were added to a polymerization vessel having a stirring blade, potassium acetate and magnesium acetate as catalysts were loaded thereinto, depressurization of the polymerization vessel and nitrogen injection thereinto were performed twice for purging with nitrogen, thereafter acetic anhydride (1.05 molar equivalents relative to a hydroxyl group) was further added, and the resultant was heated to 150° C. and subjected to an acetylation reaction in a reflux state for 2 hours.

After completion of the acetylation, the polymerization vessel in the state where acetic acid was distilled out was heated at 0.5° C./min, a polymerized product was extracted after the temperature of a melt in this tank reached 305° C., and the polymerized product was cooled and solidified. The polymerized product obtained was pulverized to a size so as to pass through a sieve having an aperture of 2.0 mm, and thus a prepolymer was obtained.

Next, the prepolymer obtained was heated in an oven from room temperature to 295° C. over 11 hours, to thereby perform solid phase polymerization. Thereafter, heat was released naturally at room temperature, and thus a liquid crystal polymer resin 1 was obtained. The liquid crystal polymer resin 1 was heated and molten on a microscope heating stage and was then confirmed based on the presence of optical anisotropy to exhibit liquid crystallinity, by use of a polarization microscope (trade name: BH-2) manufactured by OLYMPUS CORPORATION, equipped with a hot stage for microscopes (trade name: FP82HT) manufactured by METTLER TOLEDO.

### Synthesis Example 2

Raw material monomers, 60% by mol of HBA, 15% by mol of BP, 7% by mol of TPA, 3% by mol of IPA, 5% by mol of acetaminophen (AAP), and 10% by mol of 1,4-cyclohexanedicarboxylic acid (CHDA), were added to a polymerization vessel having a stirring blade, potassium acetate and magnesium acetate as catalysts were loaded thereinto, depressurization of the polymerization vessel and nitrogen injection thereinto were performed twice for purging with nitrogen, thereafter acetic anhydride (1.05 molar equivalents relative to a hydroxyl group) was further added, and the resultant was heated to 150° C. and subjected to an acetylation reaction in a reflux state for 2 hours.

After completion of the acetylation, the polymerization vessel in the state where acetic acid was distilled out was heated at 0.5° C./min, a polymerized product was extracted after the temperature of a melt in this tank reached 300° C., and the polymerized product was cooled and solidified. The polymerized product obtained was pulverized to a size so as to pass through a sieve having an aperture of 2.0 mm, and thus a prepolymer was obtained.

Next, the prepolymer obtained was heated in an oven from room temperature to 300° C. over 8 hours and then retained at 300° C. for 1 hour, to thereby perform solid phase polymerization. Thereafter, heat was released naturally at room temperature, and thus a liquid crystal polymer resin 2 was obtained. The liquid crystal polymer resin 2 was heated and molten on a microscope heating stage and was then confirmed based on the presence of optical anisotropy to exhibit liquid crystallinity, by use of a polarization microscope (trade name: BH-2) manufactured by OLYMPUS CORPORATION, equipped with a hot stage for microscopes (trade name: FP82HT) manufactured by METTLER TOLEDO.

### Synthesis Example 3

Raw material monomers, 73% by mol of HBA and 27% by mol of 6-hydroxy-2-naphthoic acid (HNA), were added to a polymerization vessel having a stirring blade with a torque meter, potassium acetate and magnesium acetate as catalysts were loaded thereinto, depressurization of the polymerization vessel and nitrogen injection thereinto were performed twice for purging with nitrogen, thereafter acetic anhydride (1.03 molar equivalents relative to a hydroxyl group) was further added, and the resultant was heated to 150° C. and subjected to an acetylation reaction in a reflux state for 30 minutes.

After completion of the acetylation, the polymerization vessel in the state where acetic acid was distilled out was heated at 0.5° C./min, and depressurized to 10 mmHg over 80 minutes after the temperature of a melt in this tank reached 320° C. After the stirring torque exhibited a predetermined value, nitrogen was introduced for conversion from a depressurized state through an ordinary pressure to a pressurized state, and a liquid crystal polymer resin 3 was drawn and obtained from the lower portion of the polymerization vessel. The liquid crystal polymer resin 3 was heated and molten on a microscope heating stage and was then confirmed based on the presence of optical anisotropy to exhibit liquid crystallinity, by use of a polarization microscope (trade name: BH-2) manufactured by OLYMPUS CORPORATION, equipped with a hot stage for microscopes (trade name: FP82HT) manufactured by METTLER TOLEDO.

### Synthesis Example 4

Raw material monomers, 62% by mol of HBA, 10% by mol of HNA, 6% by mol of BP, 8% by mol of hydroquinone (HQ), and 14% by mol of TPA, were added to a polymerization vessel having a stirring blade, potassium acetate and magnesium acetate as catalysts were loaded thereinto, depressurization of the polymerization vessel and nitrogen injection thereinto were performed three times for purging with nitrogen, thereafter acetic anhydride (1.08 molar equivalents relative to a hydroxyl group) was further added, and the resultant was heated to 150° C. and subjected to an acetylation reaction in a reflux state for 2 hours.

After completion of the acetylation, the polymerization vessel in the state where acetic acid was distilled out was heated at 0.5° C./min, a polymerized product was extracted after the temperature of a melt in this tank reached 310° C., and the polymerized product was cooled and solidified. The polymerized product obtained was pulverized to a size so as to pass through a sieve having an aperture of 1.0 mm, and thus a prepolymer was obtained.

Next, the prepolymer obtained was heated in an oven from room temperature to 290° C. over 12 hours and then retained at 290° C. for 1 hour, to thereby perform solid phase polymerization. Thereafter, heat was released naturally at room temperature, and thus a liquid crystal polymer resin 4 was obtained. The liquid crystal polymer resin 4 was heated and molten on a microscope heating stage and was then confirmed based on the presence of optical anisotropy to exhibit liquid crystallinity, by use of a polarization microscope (trade name: BH-2) manufactured by OLYMPUS CORPORATION, equipped with a hot stage for microscopes (trade name: FP82HT) manufactured by METTLER TOLEDO.

### Synthesis Example 5

Raw material monomers, 60% by mol of HBA, 20% by mol of BP, 15% by mol of TPA, and 5% by mol of IPA, were added to a polymerization vessel having a stirring blade, potassium acetate and magnesium acetate as catalysts were loaded thereinto, depressurization of the polymerization vessel and nitrogen injection thereinto were performed twice for purging with nitrogen, thereafter acetic anhydride (1.05 molar equivalents relative to a hydroxyl group) was further added, and the resultant was heated to 150° C. and subjected to an acetylation reaction in a reflux state for 2 hours.

After completion of the acetylation, the polymerization vessel in the state where acetic acid was distilled out was heated at 0.5° C./min, a polymerized product was extracted after the temperature of a melt in this tank reached 305° C., and the polymerized product was cooled and solidified. The polymerized product obtained was pulverized to a size so as to pass through a sieve having an aperture of 2.0 mm, and thus a prepolymer was obtained.

Next, the prepolymer obtained was heated in an oven from room temperature to 250° C. over 8.5 hours, to thereby perform solid phase polymerization. Thereafter, heat was released naturally at room temperature, and thus a liquid crystal polymer resin 5 was obtained. The liquid crystal polymer resin 5 was heated and molten on a microscope heating stage and was then confirmed based on the presence of optical anisotropy to exhibit liquid crystallinity, by use of a polarization microscope (trade name: BH-2) manufactured by OLYMPUS CORPORATION, equipped with a hot stage for microscopes (trade name: FP82HT) manufactured by METTLER TOLEDO.

The structural units (composition of each monomer) of the liquid crystal polymers 1 to 5 obtained above were shown in Table 1.

TABLE 1

| | Liquid | Composition (% by mol) | | | | | | | |
|---|---|---|---|---|---|---|---|---|---|
| | crystal | Structural | | Structural | | Structural | | Structural | Structural |
| | polymer | unit (I) | | unit (II) | | unit (III) | | unit (IV) | unit (V) |
| | resin | HBA | HNA | BP | HQ | TPA | IPA | AAP | CHDA |
| Synthesis | 1 | 60 | — | 20 | — | 15 | 5 | — | — |
| Example 1 | | | | | | | | | |
| Synthesis | 2 | 60 | — | 15 | — | 7 | 3 | 5 | 10 |
| Example 2 | | | | | | | | | |
| Synthesis | 3 | 73 | 27 | — | — | — | — | — | — |
| Example 3 | | | | | | | | | |
| Synthesis | 4 | 62 | 10 | 6 | 8 | 14 | — | — | −10 |
| Example 4 | | | | | | | | | |
| Synthesis | 5 | 60 | — | 20 | — | 15 | 5 | — | — |
| Example 5 | | | | | | | | | |

### <Preparation of Amorphous Resin>

The following amorphous resins were prepared.
Polyarylate 1 (PAR1) (trade name: U polymer U-100 L type manufactured by UNITIKA LTD.)
Polyarylate 2 (PAR2) (trade name: U polymer U-100 C type manufactured by UNITIKA LTD.)
Polyarylate 3 (PAR3) (trade name: U polymer U-100 D type manufactured by UNITIKA LTD.)
Polyethersulfone 1 (PESU1) (trade name: Virantage VW-10200 RFP manufactured by Solvay S.A.)
Polyethersulfone 2 (PESU2) (trade name: Virantage VW-10700 RFP manufactured by Solvay S.A.)
Polysulfone (PSU) (trade name: Udel P-1700 NT 11 manufactured by Solvay S.A.)
Polyphenylene ether (PPE) (trade name: IUPIACE PX100L manufactured by Mitsubishi Engineering-Plastics Corporation)
Polycarbonate (PC) (trade name: SD2201W manufactured by Sumika Polycarbonate Ltd.)

### <Preparation of Inorganic Filling Agent>

The following inorganic filling agents were prepared.
Talc 1 (trade name: MS-KY manufactured by Nippon Talc Co., Ltd.)
Talc 2 (trade name: PK-C manufactured by HAYASHI-KASEI)
Wollastonite (trade name: KGP-H45 manufactured by KANSAI MATEC Co., Ltd.)
Barium sulfate (trade name: BARIACE B-55 manufactured by Sakai Chemical Industry Co., Ltd.)
Calcium pyrophosphate (trade name: calcium pyrophosphate manufactured by TAIHEI CHEMICAL INDUSTRIAL CO., LTD.)
Titanium oxide (trade name: D2378 manufactured by Sakai Chemical Industry Co., Ltd.)
Mica (trade name: AB-25S manufactured by YAMAGUCHI MICA CO., LTD.)
Glass fiber (trade name: EFH150-01 manufactured by Central Glass Co., Ltd.)

### <Preparation of Epoxy Group-Containing Copolymer>

The following epoxy group-containing copolymer was prepared.
Epoxy group-containing copolymer (trade name: BONDFAST 2C manufactured by Sumitomo Chemical Co., Ltd.)

### <Production of Resin Composition>

### Example 1

A pellet-shaped resin composition was obtained by dry blending 70.0 parts by mass of the liquid crystal polymer resin 1 and 28.6 parts by mass of the liquid crystal polymer resin 2 (98.6 parts by mass in total of the liquid crystal polymer resins) obtained above, 1.4 parts by mass of the PAR1, and 42.9 parts by mass of the talc 1, then kneading them at a temperature of 380° C. by a two-axis extruder (PCM30 manufactured by Ikegai Corp.), and forming a pellet by strand cutting.

### Example 2

A pellet-shaped resin composition was obtained in the same manner as in Example 1 except that 67.1 parts by mass of the liquid crystal polymer resin 1 and 28.6 parts by mass of the liquid crystal polymer resin 2 (95.7 parts by mass in total of the liquid crystal polymer resins) obtained above, 4.3 parts by mass of the PAR1, and 42.9 parts by mass of the talc 1 were dry blended.

### Comparative Example 1

A pellet-shaped resin composition was obtained in the same manner as in Example 1 except that 71.4 parts by mass of the liquid crystal polymer resin 1 and 28.6 parts by mass of the liquid crystal polymer resin 2 (100 parts by mass in total of the liquid crystal polymer resins) obtained above, and 42.9 parts by mass of the talc were dry blended.

### Example 3

A pellet-shaped resin composition was obtained in the same manner as in Example 1 except that 93.8 parts by mass of the liquid crystal polymer resin 1 obtained above, 6.3 parts by mass of the PAR1, and 25.0 parts by mass of the wollastonite were dry blended.

### Example 4

A pellet-shaped resin composition was obtained in the same manner as in Example 1 except that 62.5 parts by mass of the liquid crystal polymer resin 1 obtained above, 37.5 parts by mass of the PESU1, and 25.0 parts by mass of the wollastonite were dry blended.

### Example 5

A pellet-shaped resin composition was obtained in the same manner as in Example 1 except that 87.5 parts by mass of the liquid crystal polymer resin 1 obtained above, 12.5 parts by mass of the PSU, and 25.0 parts by mass of the wollastonite were dry blended.

### Comparative Example 2

A pellet-shaped resin composition was obtained in the same manner as in Example 1 except that 100 parts by mass of the liquid crystal polymer resin 1 obtained above and 25.0 parts by mass of the wollastonite were dry blended.

### Example 6

A pellet-shaped resin composition was obtained in the same manner as in Example 1 except that 90.9 parts by mass of the liquid crystal polymer resin 1 obtained above, 9.1 parts by mass of the PAR1, and 81.8 parts by mass of the talc 1 were dry blended.

### Example 7

A pellet-shaped resin composition was obtained in the same manner as in Example 1 except that 90.9 parts by mass of the liquid crystal polymer resin 1 obtained above, 9.1 parts by mass of the PAR2, and 81.8 parts by mass of the talc 1 were dry blended.

### Example 8

A pellet-shaped resin composition was obtained in the same manner as in Example 1 except that 90.9 parts by mass of the liquid crystal polymer resin 1 obtained above, 9.1 parts by mass of the PAR3, and 81.8 parts by mass of the talc 1 were dry blended.

### Comparative Example 3

A pellet-shaped resin composition was obtained in the same manner as in Example 1 except that 100 parts by mass of the liquid crystal polymer resin 1 obtained above and 81.8 parts by mass of the talc 1 were dry blended.

### Example 9

A pellet-shaped resin composition was obtained in the same manner as in Example 1 except that 85.7 parts by mass of the liquid crystal polymer resin 2 obtained above, 14.3 parts by mass of the PAR1, and 42.9 parts by mass of the talc 1 were dry blended, and kneaded at a temperature of 360° C.

### Example 10

A pellet-shaped resin composition was obtained in the same manner as in Example 9 except that 85.7 parts by mass of the liquid crystal polymer resin 2 obtained above, 14.3 parts by mass of the PESU2, and 42.9 parts by mass of the talc 1 were dry blended.

### Example 11

A pellet-shaped resin composition was obtained in the same manner as in Example 9 except that 85.7 parts by mass of the liquid crystal polymer resin 2 obtained above, 14.3 parts by mass of the PSU, and 42.9 parts by mass of the talc 1 were dry blended.

### Comparative Example 4

A pellet-shaped resin composition was obtained in the same manner as in Example 9 except that 100 parts by mass of the liquid crystal polymer resin 2 obtained above and 42.9 parts by mass of the talc 1 were dry blended.

### Example 12

A pellet-shaped resin composition was obtained in the same manner as in Example 1 except that 92.9 parts by mass of the liquid crystal polymer resin 1 obtained above, 7.1 parts by mass of the PAR1, and 42.9 parts by mass of the talc 1 were dry blended.

### Example 13

A pellet-shaped resin composition was obtained in the same manner as in Example 1 except that 85.7 parts by mass of the liquid crystal polymer resin 1 obtained above, 14.3 parts by mass of the PAR1, and 42.9 parts by mass of the talc 1 were dry blended.

### Example 14

A pellet-shaped resin composition was obtained in the same manner as in Example 1 except that 71.4 parts by mass of the liquid crystal polymer resin 1 obtained above, 28.6 parts by mass of the PAR1, and 42.9 parts by mass of the talc 1 were dry blended.

### Example 15

A pellet-shaped resin composition was obtained in the same manner as in Example 1 except that 85.7 parts by mass of the liquid crystal polymer resin 1 obtained above, 14.3 parts by mass of the PAR2, and 42.9 parts by mass of the talc 1 were dry blended.

### Example 16

A pellet-shaped resin composition was obtained in the same manner as in Example 1 except that 85.7 parts by mass of the liquid crystal polymer resin 1 obtained above, 14.3 parts by mass of the PSU, and 42.9 parts by mass of the talc 1 were dry blended.

### Example 17

A pellet-shaped resin composition was obtained in the same manner as in Example 1 except that 92.9 parts by mass of the liquid crystal polymer resin 1 obtained above, 7.1 parts by mass of the PPE, and 42.9 parts by mass of the talc 1 were dry blended.

### Example 18

A pellet-shaped resin composition was obtained in the same manner as in Example 1 except that 85.7 parts by mass of the liquid crystal polymer resin 1 obtained above, 14.3 parts by mass of the PPE, and 42.9 parts by mass of the talc 1 were dry blended.

### Comparative Example 5

A pellet-shaped resin composition was obtained in the same manner as in Example 1 except that 100 parts by mass of the liquid crystal polymer resin 1 obtained above and 42.9 parts by mass of the talc 1 were dry blended.

### Example 19

A pellet-shaped resin composition was obtained in the same manner as in Example 1 except that 78.5 parts by mass of the liquid crystal polymer resin 1 and 13.8 parts by mass of the liquid crystal polymer resin 5 (92.3 parts by mass in total of the liquid crystal polymer resins) obtained above, 7.7 parts by mass of the PPE, and 53.8 parts by mass of the talc 1 were dry blended.

### Comparative Example 6

A pellet-shaped resin composition was obtained in the same manner as in Example 1 except that 86.2 parts by mass of the liquid crystal polymer resin 1 and 13.8 parts by mass of the liquid crystal polymer resin 5 (100 parts by mass in total of the liquid crystal polymer resins) obtained above, and 53.8 parts by mass of the talc 1 were dry blended.

### Example 20

A pellet-shaped resin composition was obtained in the same manner as in Example 1 except that 90.0 parts by mass of the liquid crystal polymer resin 3 obtained above, 10.0 parts by mass of the PAR1, parts by mass of the talc 2, 50.0 parts by mass of the calcium pyrophosphate, and 10.0 parts by mass of the barium sulfate were dry blended, and kneaded at a temperature of 330° C.

### Example 21

A pellet-shaped resin composition was obtained in the same manner as in Example 20 except that 90.0 parts by mass of the liquid crystal polymer resin 3 obtained above, 10.0 parts by mass of the PC, parts by mass of the talc 2, 50.0 parts by mass of the calcium pyrophosphate, and 10.0 parts by mass of the barium sulfate were dry blended.

### Comparative Example 7

A pellet-shaped resin composition was obtained in the same manner as in Example 20 except that 100.0 parts by mass of the liquid crystal polymer resin 3 obtained above, 40.0 parts by mass of the talc 2, parts by mass of the calcium pyrophosphate, and 10.0 parts by mass of the barium sulfate were dry blended.

### Example 22

A pellet-shaped resin composition was obtained in the same manner as in Example 1 except that 90.0 parts by mass of the liquid crystal polymer resin 4 obtained above, 10.0 parts by mass of the PAR1, parts by mass of the talc 2, 50.0 parts by mass of the calcium pyrophosphate, and 10.0 parts by mass of the titanium oxide were dry blended, and kneaded at a temperature of 360° C.

### Example 23

A pellet-shaped resin composition was obtained in the same manner as in Example 22 except that 75.0 parts by mass of the liquid crystal polymer resin 4 obtained above, 25.0 parts by mass of the PAR1, parts by mass of the talc 2, 50.0 parts by mass of the calcium pyrophosphate, and 10.0 parts by mass of the titanium oxide were dry blended.

### Example 24

A pellet-shaped resin composition was obtained in the same manner as in Example 22 except that 70.0 parts by mass of the liquid crystal polymer resin 4 obtained above, 30.0 parts by mass of the PAR1, parts by mass of the talc 2, 50.0 parts by mass of the calcium pyrophosphate, and 10.0 parts by mass of the titanium oxide were dry blended.

### Example 25

A pellet-shaped resin composition was obtained in the same manner as in Example 22 except that 90.0 parts by mass of the liquid crystal polymer resin 4 obtained above, 10.0 parts by mass of the PAR1, parts by mass of the talc 2, 50.0 parts by mass of the calcium pyrophosphate, 10.0 parts by mass of the titanium oxide, and 2.2 parts by mass of the epoxy group-containing copolymer were dry blended.

### Comparative Example 8

A pellet-shaped resin composition was obtained in the same manner as in Example 22 except that 100.0 parts by mass of the liquid crystal polymer resin 4 obtained above, 40.0 parts by mass of the talc 2, parts by mass of the calcium pyrophosphate, and 10.0 parts by mass of the titanium oxide were dry blended.

### Example 26

A pellet-shaped resin composition was obtained in the same manner as in Example 1 except that 90.0 parts by mass of the liquid crystal polymer resin 1 obtained above, 10.0 parts by mass of the PAR1, parts by mass of the mica, and 50.0 parts by mass of the glass fiber were dry blended.

### Comparative Example 9

A pellet-shaped resin composition was obtained in the same manner as in Example 1 except that 100.0 parts by mass of the liquid crystal polymer resin 1 obtained above, 50.0 parts by mass of the mica, and 50.0 parts by mass of the glass fiber were dry blended.

### <Production/Evaluation of Resin Molded Article>

### (Measurement of Bending Strength)

The pellet-shaped resin compositions obtained in Examples and Comparative Examples described above were each injection molded with an injection molding machine (SE30DUZ manufactured by Sumitomo Heavy Industries, Ltd.) at the following highest cylinder temperature, a rate of injection of 100 mm/sec, and a mold temperature of 80° C., to thereby produce a bending test piece according to ASTM D790.

### (Highest Cylinder Temperature)

Examples 1, 2, 9 to 11 and 22 to 25, and Comparative Examples 1, 4 and 8: 350° C.

Examples 3 to 8, 12 to 19 and 26, and Comparative Examples 2, 3, 6 and 9: 360° C.

Examples 20 and 21, and Comparative Example 7: 330° C.

Subsequently, the bending test piece produced was used to measure the bending strength (MPa) according to ASTM D790.

### (Measurement of Adhesion Strength)

The pellet-shaped resin compositions obtained in Examples and Comparative Examples described above were each injection molded with an injection molding machine (SE30DU manufactured by Sumitomo Heavy Industries, Ltd.) at the following highest cylinder temperature, a rate of injection of 100 mm/sec, and a mold temperature of 80° C., to thereby produce a molded article of 100 mm×25 mm×1.6 mm, according to JIS K 6850.

### (Highest Cylinder Temperature)

Examples 1, 2, 9 to 11 and 22 to 25, and Comparative Examples 1, 4 and 8: 350° C.

Examples 3 to 8, 12 to 19 and 26, and Comparative Examples 2, 3, 5, 6 and 9: 360° C.

Examples 20 and 21, and Comparative Example 7: 330° C.

Subsequently, the molded article produced and the bottom surface of a stainless cylinder having a diameter of 8 mm were bonded by an epoxy-based adhesive (3128NH manufactured by Henkel AG & Co. KGaA), to thereby produce a composite. A section of the side surface of the stainless cylinder of the composite obtained, located at a position of 2.5 mm from the surface of the molded article, was pushed at a rate of 127 mm/sec in a direction parallel with the molded article, and the adhesion strength (N) at an interface between the molded article and the stainless cylinder was measured with a universal tester (33R 4204-type tester manufactured by Instron).

The compositions of the resin compositions and the measurement results of the resin molded articles, in Examples 1 to 26 and Comparative Examples 1 to 9, are shown in Table 2 and Table 3.

TABLE 2

| | Composition of resin composition | | | | | | | | | |
|---|---|---|---|---|---|---|---|---|---|---|
| | Liquid crystal polymer | | | | | | Epoxy group-containing | | Performance evaluation | |
| | resin | | Amorphous resin | | Inorganic filling agent | | copolymer | | Mechanical | Adhesion |
| | | Amount of | | Amount of | | Amount of | | Amount of | strength | strength |
| | | compounding | | compounding | | compounding | | compounding | Bending | Adhesion |
| | | (parts by | | (parts by | | (parts by | | (parts by | strength | strength |
| | Type | mass) | Type | mass) | Type | mass) | Type | mass) | [MPa] | [N] |
| Example 1 | 1, 2 | 98.6 | PAR1 | 1.4 | Talc 1 | 42.9 | — | 0 | 112 | 47 |
| Example 2 | 1, 2 | 95.7 | PAR1 | 4.3 | Talc 1 | 42.9 | — | 0 | 112 | 50 |
| Comparative | 1, 2 | 100 | — | 0 | Talc 1 | 42.9 | — | 0 | 112 | 41 |
| Example 1 | | | | | | | | | | |
| Example 3 | 1 | 93.8 | PAR1 | 6.3 | Wollastonite | 25.0 | — | 0 | 149 | 27 |
| Example 4 | 1 | 62.5 | PESU1 | 37.5 | Wollastonite | 25.0 | — | 0 | 148 | 25 |
| Example 5 | 1 | 87.5 | PSU | 12.5 | Wollastonite | 25.0 | — | 0 | 148 | 24 |
| Comparative | 1 | 100 | — | 0 | Wollastonite | 25.0 | — | 0 | 147 | 21 |
| Example 2 | | | | | | | | | | |
| Example 6 | 1 | 90.9 | PAR1 | 9.1 | Talc 1 | 81.8 | — | 0 | 112 | 55 |
| Example 7 | 1 | 90.9 | PAR2 | 9.1 | Talc 1 | 81.8 | — | 0 | 112 | 58 |
| Example 8 | 1 | 90.9 | PAR3 | 9.1 | Talc 1 | 81.8 | — | 0 | 112 | 55 |
| Comparative | 1 | 100 | — | 0 | Talc 1 | 81.8 | — | 0 | 108 | 44 |
| Example 3 | | | | | | | | | | |
| Example 9 | 2 | 85.7 | PAR1 | 14.3 | Talc 1 | 42.9 | — | 0 | 105 | 63 |
| Example 10 | 2 | 85.7 | PESU2 | 14.3 | Talc 1 | 42.9 | — | 0 | 100 | 61 |
| Example 11 | 2 | 85.7 | PSU | 14.3 | Talc 1 | 42.9 | — | 0 | 100 | 59 |
| Comparative | 2 | 100 | — | 0 | Talc 1 | 42.9 | — | 0 | 98 | 51 |
| Example 4 | | | | | | | | | | |
| Example 12 | 1 | 92.9 | PAR1 | 7.1 | Talc 1 | 42.9 | — | 0 | 125 | 62 |
| Example 13 | 1 | 85.7 | PAR1 | 14.3 | Talc 1 | 42.9 | — | 0 | 124 | 64 |
| Example 14 | 1 | 71.4 | PAR1 | 28.6 | Talc 1 | 42.9 | — | 0 | 128 | 52 |
| Example 15 | 1 | 85.7 | PAR2 | 14.3 | Talc 1 | 42.9 | — | 0 | 126 | 65 |
| Example 16 | 1 | 85.7 | PSU | 14.3 | Talc 1 | 42.9 | — | 0 | 119 | 59 |
| Example 17 | 1 | 92.9 | PPE | 7.1 | Talc 1 | 42.9 | — | 0 | 122 | 61 |
| Example 18 | 1 | 85.7 | PPE | 14.3 | Talc 1 | 42.9 | — | 0 | 120 | 64 |
| Comparative | 1 | 100 | — | 0 | Talc 1 | 42.9 | — | 0 | 120 | 50 |
| Example 5 | | | | | | | | | | |
| Example 19 | 1, 5 | 92.3 | PPE | 7.7 | Talc 1 | 53.8 | — | 0 | 115 | 66 |
| Comparative | 1, 5 | 100 | — | 0 | Talc 1 | 53.8 | — | 0 | 119 | 62 |
| Example 6 | | | | | | | | | | |

TABLE 3

| | Composition of resin composition | | | | |
|---|---|---|---|---|---|
| | Liquid crystal polymer resin | | Amorphous resin | | |
| | | Amount of | | Amount of | Inorganic |
| | | compounding | | compounding | filling agent |
| | Type | (parts by mass) | Type | (parts by mass) | Type |
| Example 20 | 3 | 90.0 | PAR1 | 10.0 | Talc 2, Ba sulfate, |
| | | | | | Calcium pyrophosphate |
| Example 21 | 3 | 90.0 | PC | 10.0 | Talc 2, Ba sulfate, |
| | | | | | Calcium pyrophosphate |
| Comparative | 3 | 100.0 | — | 0 | Talc 2, Ba sulfate, |
| Example 7 | | | | | Calcium pyrophosphate |
| Example 22 | 4 | 90.0 | PAR1 | 10.0 | Talc 2, Ti oxide, |
| | | | | | Calcium pyrophosphate |
| Example 23 | 4 | 75.0 | PAR1 | 25.0 | Talc 2, Ti oxide, |
| | | | | | Calcium pyrophosphate |
| Example 24 | 4 | 70.0 | PAR1 | 30.0 | Talc 2, Ti oxide, |
| | | | | | Calcium pyrophosphate |
| Example 25 | 4 | 90.0 | PAR1 | 10.0 | Talc 2, Ti oxide, |
| | | | | | Calcium pyrophosphate |
| Comparative | 4 | 100.0 | — | 0 | Talc 2, Ba sulfate, |
| Example 8 | | | | | Calcium pyrophosphate |
| Example 26 | 1 | 90.0 | PAR1 | 10.0 | Mica, glass fiber |
| Comparative | 1 | 100.0 | — | 0 | Mica, glass fiber |
| Example 9 | | | | | |

| | Composition of resin composition | | | Performance evaluation | |
|---|---|---|---|---|---|
| | Inorganic | Epoxy group- | | Mechanical | Adhesion |
| | filling agent | containing copolymer | | strength | strength |
| | Amount of | | Amount of | Bending | Adhesion |
| | compounding | | compounding | strength | strength |
| | (parts by mass) | Type | (parts by mass) | [MPa] | [N] |
| Example 20 | 100.0 | — | 0 | 128 | 62 |
| Example 21 | 100.0 | — | 0 | 128 | 53 |
| Comparative | 100.0 | — | 0 | 129 | 48 |
| Example 7 | | | | | |
| Example 22 | 100.0 | — | 0 | 109 | 76 |
| Example 23 | 100.0 | — | 0 | 100 | 70 |
| Example 24 | 100.0 | — | 0 | 100 | 69 |
| Example 25 | 100.0 | Epoxy group- | 2.2 | 104 | 79 |
| | | containing | | | |
| | | copolymer | | | |
| Comparative | 100.0 | — | 0 | 107 | 66 |
| Example 8 | | | | | |
| Example 26 | 100.0 | — | 0 | 151 | 78 |
| Comparative | | — | 0 | 159 | 56 |
| Example 9 | 100.0 | | | | |

As clear from the above results, the resin molded articles of Examples 1 and 2 were not reduced in bending strength and were enhanced in adhesion strength to an adhesive as compared with the resin molded article of Comparative Example 1 which was the same as these Examples in terms of the type and the amount of compounding of the inorganic filler.

The resin molded articles of Examples 3 to 5 were almost not changed in bending strength and were enhanced in adhesion strength to an adhesive as compared with the resin molded article of Comparative Example 2 which was the same as these Examples in terms of the type and the amount of compounding of the inorganic filler.

The resin molded articles of Examples 6 to 8 were almost not changed in bending strength and were enhanced in adhesion strength to an adhesive as compared with the resin molded article of Comparative Example 3 which was the same as these Examples in terms of the type and the amount of compounding of the inorganic filler.

The resin molded articles of Examples 9 to 11 were almost not changed in bending strength and were enhanced in adhesion strength to an adhesive as compared with the resin molded article of Comparative Example 4 which was the same as these Examples in terms of the type and the amount of compounding of the inorganic filler.

The resin molded articles of Examples 12 to 18 were almost not changed in bending strength and were enhanced in adhesion strength to an adhesive as compared with the resin molded article of Comparative Example 5 which was the same as these Examples in terms of the type and the amount of compounding of the inorganic filler.

The resin molded article of Example 19 was almost not changed in bending strength and was enhanced in adhesion strength to an adhesive as compared with the resin molded article of Comparative Example 6 which was the same as this Example in terms of the type and the amount of compounding of the inorganic filler.

The resin molded articles of Examples 20 to 21 were almost not changed in bending strength and were enhanced in adhesion strength to an adhesive as compared with the resin molded article of Comparative Example 7 which was the same as these Examples in terms of the type and the amount of compounding of the inorganic filler.

The resin molded articles of Examples 22 to 25 were almost not changed in bending strength and were enhanced in adhesion strength to an adhesive as compared with the resin molded article of Comparative Example 8 which was the same as these Examples in terms of the type and the amount of compounding of the inorganic filler.

The resin molded article of Example 26 was almost not changed in bending strength and was enhanced in adhesion strength to an adhesive as compared with the resin molded article of Comparative Example 9 which was the same as the Example in terms of the type and the amount of compounding of the inorganic filler.

1. A method for enhancing adhesion strength of a resin molded article made of a resin composition comprising a liquid crystal polymer resin and an inorganic filling agent, to an adhesive, wherein
an amorphous resin is further compounded into the resin composition, and
an amount of compounding of the liquid crystal polymer resin, an amount of compounding of the amorphous resin, and an amount of compounding of the inorganic filling agent are respectively regulated to 50 parts by mass or more and 99 parts by mass or less, 1 part by mass or more and 50 parts by mass or less, and 0.1 parts by mass or more and 120 parts by mass or less, based on 100 parts by mass in total of the liquid crystal polymer resin and the amorphous resin.

2. The method for enhancing adhesion strength according to claim 1, wherein the amount of compounding of the liquid crystal polymer resin and the amount of compounding of the amorphous resin are respectively regulated to 70 parts by mass or more and 99 parts by mass or less and 1 part by mass or more and 30 parts by mass or less.

3. The method for enhancing adhesion strength according to claim 1, wherein the amorphous resin is at least one selected from the group consisting of polyarylate, polyethersulfone, polysulfone, polyphenylene ether, and polycarbonate.

4. The method for enhancing adhesion strength according to claim 1, wherein the amorphous resin is at least one selected from the group consisting of polyarylate and polysulfone.

5. The method for enhancing adhesion strength according to claim 1, wherein 1 part by mass or more and 5 parts by mass or less of an epoxy group-containing copolymer based on 100 parts by mass in total of the liquid crystal polymer resin and the amorphous resin is further compounded into the resin composition.

6. The method for enhancing adhesion strength according to claim 1, wherein the liquid crystal polymer resin contains the following structural unit (I) derived from hydroxycarboxylic acid: 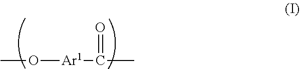
wherein Ar¹ is selected from the group consisting of a phenyl group, a biphenyl group, a 4,4′-isopropylidenediphenyl group, a naphthyl group, an anthryl group and a phenanthryl group each optionally having a substituent.

7. The method for enhancing adhesion strength according to claim 6, wherein the liquid crystal polymer resin further contains
the following structural unit (II) derived from a diol compound: 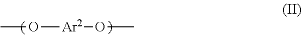
wherein Ar² is selected from the group consisting of a phenyl group, a biphenyl group, a 4,4′-isopropylidenediphenyl group, a naphthyl group, an anthryl group and a phenanthryl group each optionally having a substituent; and
the following structural unit (III) derived from dicarboxylic acid: 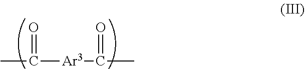
wherein Ar³ is selected from the group consisting of a phenyl group, a biphenyl group, a 4,4′-isopropylidenediphenyl group, a naphthyl group, an anthryl group and a phenanthryl group each optionally having a substituent.

8. The method for enhancing adhesion strength according to claim 6, wherein the liquid crystal polymer resin further contains the following structural unit (IV).

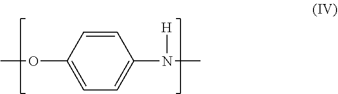

9. The method for enhancing adhesion strength according to claim 6, wherein the liquid crystal polymer resin further contains the following structural unit (V).

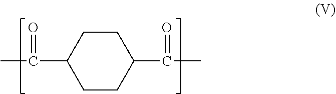

10. The method for enhancing adhesion strength according to claim 1, wherein the inorganic filling agent is at least one selected from the group consisting of talc, mica, glass, silica, wollastonite, barium sulfate, calcium pyrophosphate, calcium sulfate, calcium titanate, calcium carbonate, zinc oxide, titanium oxide, carbon black, and carbon fiber.

11. The method for enhancing adhesion strength according to claim 1, wherein the adhesive is an epoxy-based adhesive and/or an acrylate-based adhesive.

12. A resin composition for use in a method for enhancing adhesion strength of a resin molded article to an adhesive, the resin composition comprising
50 parts by mass or more and 99 parts by mass or less of a liquid crystal polymer resin and 1 part by mass or more and 50 parts by mass or less of an amorphous resin, and 0.1 parts by mass or more and 120 parts by mass or less of an inorganic filling agent based on 100 parts by mass in total of the liquid crystal polymer resin and the amorphous resin.

13. A composite obtained by bonding a resin molded article made of a resin composition comprising 50 parts by mass or more and 99 parts by mass or less of a liquid crystal polymer resin and 1 part by mass or more and 50 parts by mass or less of an amorphous resin, and 0.1 parts by mass or more and 120 parts by mass or less of an inorganic filling agent based on 100 parts by mass in total of the liquid crystal polymer resin and the amorphous resin, with other member, by an adhesive.

14. The composite according to claim 13, wherein the adhesive is an epoxy-based adhesive and/or an acrylate-based adhesive.

15. A camera module component comprising the composite according to claim 13, as a constituent member.
